(19) United States
(12) Patent Application Publication
(10) Pub. No.: US 2002/0050152 A1
(43) Pub. Date: May 2, 2002

(54) Synthetic silica glass molding method, synthetic silica glass molding apparatus, and synthetic silica glass

(76) Inventors: Seishi Fujiwara, Sagamihara-shi (JP); Hiroki Jinbo, Yokohama-shi (JP); Norio Komine, Sagamihara-shi (JP)

Correspondence Address: MORGAN, LEWIS & BOCKIUS, 1800 M STREET NW, WASHINGTON, DC, 20036-5869, US

(21) Appl. No.: 09/923,801

(22) Filed: Aug. 8, 2001

(30) Foreign Application Priority Data
Aug. 10, 2000 (JP) 2000-242638
Aug. 10, 2000 (JP) 2000-242639

(51) Int. Cl. C03B 11/06; C03B 19/04

(52) U.S. Cl. 65/32.1; 65/374.15; 65/144; 65/157; 65/302

(57) ABSTRACT

A method is provided for molding a synthetic silica glass member. The method includes accommodating a synthetic silica glass bulk inside a molding vessel; interposing an elastic member having a ventilating property between a pressing member and the synthetic silica glass bulk; providing a fastener for fastening at least peripheral edge portions of the elastic member to the pressing member; and pressing the synthetic silica glass bulk against the molding vessel by the pressing member in a high-temperature condition to mold the synthetic silica glass bulk into a synthetic silica glass member having a shape conforming to a shape of the space defined by the pressing member and the molding vessel, the synthetic silica glass bulk being pressed in such a manner that the pressing member and the elastic member tightly fasten to each other through the fastener.

This application claims the benefit of Japanese Applications No. 2000-242638 and No. 2000-242639, both filed in Japan on Aug. 10, 2000, which are hereby incorporated by reference.

### BACKGROUND OF THE INVENTION

1. Field of the Invention

The present invention relates to a method for molding a synthetic silica glass bulk into a synthetic silica glass of a desired shape by heating and pressing, a synthetic silica glass molding apparatus, and a synthetic silica glass member that is molded by such a method and apparatus. In particular, the present invention relates to a synthetic silica glass member suitable for use in optical members, such as reticles (photomasks), substrates, and image-focusing optical systems.

2. Discussion of the Related Art

The present invention concerns synthetic silica glass members suitable for use in optical members, such as reticles (photomasks), substrates, and image-focusing optical systems. Such a synthetic silica glass member is molded into a desired shape by pressing and molding a synthetic silica glass bulk member. The synthetic silica glass bulk may be manufactured using a silicon compound, such as silicon tetrachloride, silane or an organo-silicon compound, as a raw material. Such a synthetic silica glass bulk may be supplied with a component that alters the refractive index, such as Ge, Ti, B, F or Al.

A reduction-type projection exposure apparatus (or photolithography apparatus) has mainly been used for transfer of integrated circuit patterns, such as IC or LSI patterns. The projection optical systems used in such apparatus must have a broad exposure area and a higher resolution over the entire exposure area in response to the increased degree of integration in integrated circuits. Possible methods of improving the resolution of such projection optical systems include shortening the exposure wavelength and increasing the numerical aperture (NA) of the projection optical system.

There has been a progressive shortening of exposure wavelengths from the g line (436 nm) to the i line (365 nm), and even further to KrF excimer laser (248 nm) and ArF excimer laser (193 nm). Furthermore, facing the ever increasing degree of integration in integrated circuits, methods that use F₂ laser (157 nm), X-rays or electron beams as light sources are currently under research and development. Among these methods, reduction-type projection exposure apparatuses using F₂ laser, which can be manufactured using existing design concepts, are currently attracting special attention.

Generally, an optical glass, which is used as an optical member in the illumination optical system or projection optical system of a reduction-type projection exposure apparatus that uses a light source with a wavelength longer than that of the i line, exhibits an abrupt drop in light transmissivity in the wavelength region shorter than that of the i line. In particular, optical glass shows almost no light transmission in the wavelength region of 250 nm or shorter.

Accordingly, synthetic silica glass or fluoride single crystals such as calcium fluoride or barium fluoride, etc., can be used as the materials of the lenses that make up the optical systems of reduction-type projection exposure apparatus that uses excimer lasers as light sources. These materials are considered indispensable for correcting color aberration in the image-focusing optical systems of excimer laser, for example.

In a reduction-type projection exposure apparatus, a reticle is one of the important elements for exposing circuit patterns on wafers. The material used in the reticle must have required transmissivity characteristics, such as sufficient durability against excimer laser irradiation. Furthermore, since a thermal expansion caused by generation of heat in its substrate is a major problem, a silica glass synthesized by the flame hydrolysis method, which has good durability as well as a small coefficient of thermal expansion, is used. Furthermore, for materials used in reticles, the chemical resistance and etching resistance characteristics are also important from the standpoint of the manufacturing process.

Among the flame hydrolysis methods, the “direct method” for manufacturing a silica glass ingot will be explained as follows. A combustion-supporting gas (generally oxygen gas) and a combustible gas (hydrogen gas or natural gas) are mixed and burned by a burner made of a synthetic silica glass. A highly pure silicon tetrachloride gas (used as a raw-material gas) is diluted with a carrier gas (oxygen gas, hydrogen gas, inert gas, etc.; typically oxygen gas is used) and is emitted from the central portion of the burner. Fine particles of a synthetic silica glass is produced by causing the raw-material gas to react with the water (hydrolysis reaction) produced by the combustion of the surrounding oxygen gas and hydrogen gas. These fine particles of synthetic silica glass are deposited on the surface of a target made of an opaque synthetic silica glass plate, etc., which is located beneath the burner. During the deposition, the target is subject to rotation, oscillation and downward-pulling motions. These fines particles are simultaneously melted and vitrified by the heat of the oxygen gas and hydrogen gas combustion. If this method is used, a synthetic silica glass ingot with a relatively large diameter can be obtained.

Another method for manufacturing synthetic silica glass ingots is a so-called VAD (vapor-phase axial deposition) method, which applies techniques used in the manufacture of optical fibers. In this method, a porous synthetic silica glass matrix is made consolidated by performing a heat treatment in an atmosphere.

The synthetic silica glass ingots manufactured by these methods are cut to form glass blocks (synthetic silica glass bulks) that have a desired shape and size to be used as optical members, such as lenses, etc. If the resulting size is not suitable, the synthetic silica glass bulks need to be molded at a high temperature using a graphite molding vessel, for example, to produce a synthetic silica glass member of a desired shape and size to be used as an optical member, such as a reticle, etc.

An example of the synthetic silica glass molding method is disclosed in Japanese Patent Application Kokai No. S56-129621. In that method, the silica glass bulk is molded by heat and pressure in a graphite molding vessel in a helium gas atmosphere with an absolute pressure between 0.1 Torr and the atmospheric pressure at a temperature of 1700° C. or greater. Thereafter, the molded glass is rapidly cooled to a temperature between 1100° C. and 1300° C. Furthermore, a molding method in which the graphite molding vessel has an upright structure split into two or more sections is disclosed in Japanese Patent Application Kokai No. S57-6703 1. A method in which molding is performed at 1600° C. to 1700° C. using a graphite molding vessel having a structure that relaxes stresses caused by the difference in thermal expansion coefficient between the synthetic silica glass and the molding vessel is disclosed in Japanese Patent Application Kokoku No. H4-54626.

However, the conventional molding methods suffer from the following drawbacks. First, gas bubbles are generated in the synthetic silica glass bulk during the press-molding at high temperatures, and these gas bubbles remain in the synthetic silica glass in large quantities after the molding. Synthetic silica glass containing such large quantities of residual gas bubbles cannot be used as optical members.

Further, in cases where a synthetic silica glass bulk is press-molded in a molding vessel, the amount of shrinkage generated when the system is cooled down to the room temperature after the high temperature molding considerably differs between the synthetic silica glass bulk and the molding vessel. This is because the synthetic silica glass bulk and the constituent materials of the molding vessel have significantly different thermal expansion coefficient values. Consequently, in the conventional method, undesirable stresses are applied to the synthetic silica glass bulk and the molding vessel. This often leads to generation of cracks in the press-molded synthetic silica glass and various damages to the molding vessel.

Furthermore, at the high temperature, the synthetic silica glass bulk may react with the constituent materials of the molding vessel. For example, in cases where a graphite molding vessel is used as the molding vessel, the synthetic silica glass bulk and graphite react at a high temperature and produce silicon carbide. Also, crystallization of the silica glass occurs at approximately 1400° C. to 1600° C. As a result, depending upon the molding temperature, undesirable recesses and projections are formed on the surface of the resulting synthetic silica glass, thereby resulting in generation of cracks and/or a loss in transmissivity.

The temperature inside the synthetic silica glass during the treatment is not always controlled to be constant. Because of this, local generation of bubbles is observed especially in a glass in which components that alter the refractive index are introduced. Moreover, the non-uniformity in the inside temperature causes uneven concentration in the resulting glass member. This problem is significant, particularly for synthetic silica glass members into which components that alter the refractive index have been introduced. Such irregularity in concentration led to a large degradation in optical properties in some cases.

Also, in cases where a synthetic silica glass is subjected to a heat/press molding treatment in a graphite molding vessel, the optical characteristics of the resulting synthetic silica glass member (especially the uniformity of the in-plane transmissivity) are often degraded. If a synthetic silica glass member having such an insufficient uniformity in the in-plane transmissivity is incorporated in an exposure apparatus as a member, the image-focusing performance of the exposure apparatus significantly degrades, which is undesirable.

### SUMMARY OF THE INVENTION

Accordingly, the present invention is directed to a synthetic silica glass molding method, a synthetic silica glass molding apparatus, and a synthetic silica glass member that substantially obviate one or more of the problems due to limitations and disadvantages of the related art.

An object of the present invention is to provide a synthetic silica glass molding method and apparatus for molding a synthetic silica glass into a desired shape without imposing adverse effects on the optical properties of the resulting glass member.

Another object of the present invention is to provide a synthetic silica glass molding method and apparatus for molding a synthetic silica glass into a desired shape suitable for suitable for use in reticle (photo-mask) substrates and image-focusing optical system lens materials.

Another object of the present invention is to provide a synthetic silica glass molding method and apparatus that achieve a sufficient uniformity in transmissivity and suppress crystallization and irregularities in concentration in the resulting synthetic silica glass member.

Another object of the present invention is to provide a synthetic silica glass molding method and apparatus for molding a synthetic silica glass into a desired shape suitable for use in reticle (photo-mask) substrates and image-focusing optical system lens materials, in which a synthetic silica glass that has been manufactured using a silicon compound, such as silicon tetrachloride, silane or an organo-silicon compound, etc., as a raw material, or a synthetic silica glass to which components that alter the refractive index, such as Ge, Ti, B, F or Al, etc., have been added, is molded through heating and pressing.

Another object of the present invention is to provide a synthetic silica glass, which possesses a sufficient uniformity in transmissivity and suppresses crystallization and irregularities in concentration and which is suitable for use in reticle (photo-mask) substrates and lens materials of image-focusing optical systems.

A further object of the present invention is to provide a synthetic silica glass, which possesses a sufficient uniformity in transmissivity and suppresses crystallization and irregularities in concentration and which is suitable for use in reticle (photo-mask) substrates and lens materials of image-focusing optical systems and a synthetic silica glass molding method for such a synthetic silica glass member in which a synthetic silica glass that has been manufactured using a silicon compound, such as silicon tetrachloride, silane or an organo-silicon compound, etc., as a raw material, or a synthetic silica glass to which components that alter the refractive index, such as Ge, Ti, B, F or Al, etc., have been added, is molded through heating and pressing.

Additional features and advantages of the invention will be set forth in the description which follows, and in part will be apparent from the description, or may be learned by practice of the invention.

The objectives and other advantages of the invention will be realized and attained by the scheme particularly pointed out in the written description and claims hereof as well as the appended drawings.

To achieve these and other advantages and in accordance with the purpose of the present invention, as embodied and broadly described, a synthetic silica glass molding method according to one aspect of the present invention includes accommodating a synthetic silica glass bulk inside a molding vessel; interposing an elastic member having a ventilating property between a pressing member and the synthetic silica glass bulk; providing a fastener for fastening at least peripheral edge portions of the elastic member to the pressing member; and pressing the synthetic silica glass bulk against the molding vessel by the pressing member in a high-temperature condition to mold the synthetic silica glass bulk into a synthetic silica glass member having a shape conforming to a shape of the space defined by the pressing member and the molding vessel, the synthetic silica glass bulk being pressed in such a manner that the pressing member and the elastic member tightly fasten to each other through the fastener.

In the first aspect above, providing the fastener may include forming the pressing member and the elastic member from the same material, and pressing the synthetic silica glass bulk against the molding vessel may include fastening the elastic member tightly to the pressing member by thermal fusion.

Here, providing the fastener may include providing a first engaging part on the pressing member and providing in the elastic member a second engaging part configured to be engaged with the first engaging part, and pressing the synthetic silica glass bulk may include engaging the first engaging part on the pressing member with the second engaging part in the elastic member so as to fasten tightly the pressing member to the elastic member.

One of the first and second engaging parts may have an L shape, and the other one of the first and second engaging parts may have a groove shape to be engaged with the L-shaped engaging part. Moreover, the elastic member may be a plate-form felt member made of carbon fibers. The pressing member may be a weight that presses against the upper surface of the synthetic silica glass bulk. Further, pressing the synthetic silica glass bulk against the molding vessel may include providing an inert gas atmosphere retained at an atmospheric pressure or higher.

In another aspect, the present invention provides a synthetic silica glass molding apparatus, including a molding vessel configured to accommodate a synthetic silica glass bulk; a heater for heating the molding vessel; a pressing member that presses the synthetic silica glass bulk in a high-temperature condition against the molding vessel to mold the synthetic silica glass bulk into a synthetic silica glass member having a shape conforming to the shape of a space defined by the pressing member and the molding vessel; an elastic member having a ventilating property, configured to be interposed between the pressing member and the synthetic silica glass bulk; and a fastener configured to fasten at least peripheral edge portions of the elastic member to the pressing member, wherein the pressing member presses the synthetic silica glass bulk in such a manner that the pressing member and the elastic member tightly fasten to each other through the fastener.

In another aspect, the present invention provides a synthetic silica glass molding method, including providing a graphite molding vessel that has been subjected to a purification treatment, providing a pressing member; providing a plate-form felt member made of carbon fibers on a surface of each of the graphite molding vessel and the pressing member to alleviate stress and suppressing deterioration of a synthetic silica glass bulk to be molded, the plate-form felt member having been subjected to a purification treatment; accommodating a synthetic silica glass bulk inside the graphite molding vessel; and pressing the synthetic silica glass bulk against the molding vessel by the pressing member in a high-temperature condition to mold the synthetic silica glass into a synthetic silica member having a shape conforming to the shape of a space defined by the pressing member and the graphite molding vessel.

Here, each of the graphite molding vessel and the felt member may have an ash content of about 10 ppm or less. The surface of the graphite molding vessel may be coated with β-SiC. Moreover, the porosity of the graphite molding vessel is preferably set to about 10% or less.

Further, pressing the synthetic silica glass bulk against the molding vessel may include providing an inert gas atmosphere retained at an atmospheric pressure or higher. Also, pressing the synthetic silica glass bulk against the molding vessel may include retaining a treatment temperature at about 1750° C. to about 1850° C. for a time period ranging from about 10 minutes to about 60 minutes.

In another aspect, the present invention provides a synthetic silica glass member manufactured by any one of the above-described methods and their modifications in which a fluctuation in transmissivity of the synthetic silica glass member in a direction perpendicular to an axis along which light is transmitted through the member is about ±1% or less per centimeter of the thickness of the member in the wavelength region of about 250 nm or less, and the synthetic silica glass member is adapted for use in an exposure apparatus employing light in the region of ultraviolet to vacuum ultraviolet.

In a further aspect, the present invention provides a synthetic silica glass member manufactured by any one of the above-described methods and their modifications in which a fluctuation in transmissivity of the synthetic silica glass member in a direction perpendicular to an axis along which light is transmitted through the member is about ±0.5% or less per ¼ inch of the thickness of the member at a wavelength of about 157.6 nm, and the synthetic silica glass member is adapted for use in a vacuum ultraviolet exposure apparatus.

In the synthetic silica glass members of the present invention, the total concentration of metal impurities contained in the member may be set to about 50 ppb or less. A fluctuation in concentration of fluorine in the member may be set to about 0.5 wt % or less.

The synthetic silica glass members of the present invention may be used as an exposure apparatus lens member or a photo-mask member for use in an exposure apparatus employing light in the region of ultraviolet to vacuum ultraviolet. The synthetic silica glass members of the present invention may also contain fluorine, and the concentration of the OH group in the synthetic silica glass member may be set to about 1 ppm or less.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic sectional view of a synthetic silica glass molding apparatus according to an example of the present invention;

FIG. 2 is a schematic sectional view illustrating press-molding of a synthetic silica glass bulk using the synthetic silica glass molding apparatus of FIG. 1;

FIG. 3 is a perspective view of a weight and an elastic member according to an example of the present invention;

FIG. 4 is a bottom view of the weight and the elastic member of FIG. 3;

FIG. 5 is a perspective view of a weight and an elastic member according to another example of the present invention;

FIG. 6 is a bottom view of the weight and the elastic member of FIG. 5;

FIG. 7 is a schematic sectional view of a synthetic silica glass molding apparatus according to another example of the present invention;

FIG. 8 is a schematic sectional view of a synthetic silica glass molding apparatus according to still another example of the present invention; and

FIG. 9 is a schematic sectional view illustrating press-molding of a synthetic silica glass bulk using the synthetic silica glass molding apparatus of FIG. 8.

### DETAILED DESCRIPTION OF THE PREFERRED EMBODIMENTS

Before describing examples of the present invention, the result of diligent research and development conducted by the present inventors is briefly described. The present inventors discovered that at least some of the above-mentioned problems can be alleviated by inserting an elastic member that absorbs pressure between the synthetic silica glass bulk and the molding vessel. In some cases, however, this measure was found not to be always sufficient.

As a result of further research conducted in an effort to solve the problems, the present inventors discovered that the insufficient results occur when there exists flexing in the elastic member (plate-form felt member made of carbon fibers) that is used on the upper surface of the synthetic silica glass bulk. Specifically, if the elastic member that is placed on the upper surface of the synthetic silica glass bulk during treatment flexes so that the peripheral edge portions droop downward, a large space is created between the peripheral edge portions of this elastic member and the weight that is pressing on the synthetic silica glass bulk. In this state, if the weight and elastic member move downward as a result of the weight of the weight as the synthetic silica glass bulk is deformed, the space may be retained until the treatment is completed, so that the synthetic silica glass bulk cannot be molded into the desired shape.

The present inventors also discovered that at least some of the above-mentioned problems can be solved by giving consideration to the materials and purity of the graphite molding vessel and plate-form felt members made of carbon fibers that are used to perform the treatment.

The present invention is conceived in view of this and other further considerations. Reference will now be made in detail to the preferred embodiments and working examples of the present invention, examples of which are illustrated in the accompanying drawings.

First Embodiment

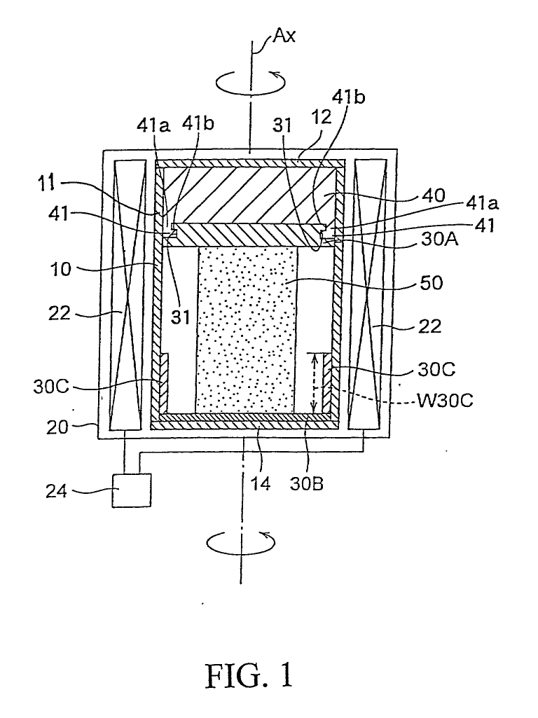

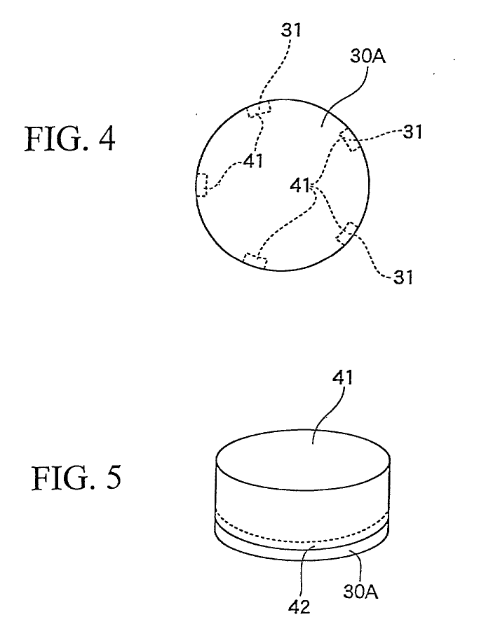

With reference to FIGS. 1 through 4, a first embodiment and working examples of the present invention will be explained. A synthetic silica glass molding apparatus of this embodiment has, as its principal components, a graphite molding vessel 10, a weight 40 used as a pressing member, elastic members 30A, 30B and 30C, which have ventilating properties, and an electric furnace 20 used as a heater.

In a preferred embodiment, the graphite molding vessel 10 has a hollow structure in which a top plate 12 and a bottom plate 14 are attached to the upper surface and lower surface of a tubular body 11 made of graphite. A synthetic silica glass bulk 50 is accommodated inside the graphite molding vessel 10, and the vessel is used to press-mold the synthetic silica glass bulk 50. The shape of the graphite molding vessel 10 is selected in accordance with the target shape of the synthetic silica glass bulk 50. For example, this shape may be round, rectangular, or any other desired shape.

An elastic member 30B which has ventilating properties is installed on the bottom plate 14, and the apparatus is arranged so that the synthetic silica glass bulk 50 is carried on the elastic member 30B. Furthermore, a weight 40 is disposed on top of the synthetic silica glass bulk 50, with an elastic member 30A which has ventilating properties interposed between the weight 40 and the synthetic silica glass bulk 50, and an elastic member 30C which has ventilating properties is disposed on the inside surface of the lower portion of the tubular body 11.

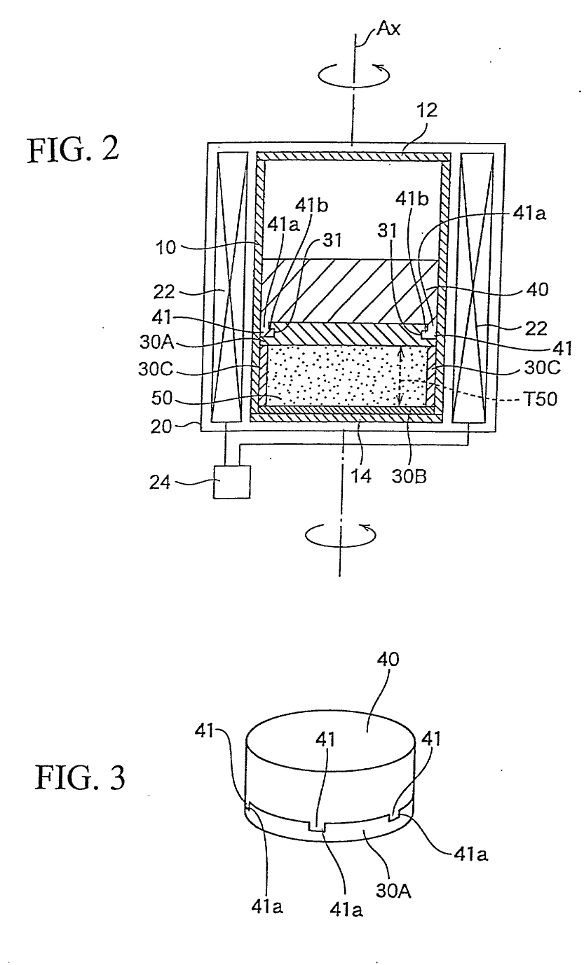

The shapes and sizes of the elastic members 30A and 30B are appropriately selected in accordance with the shape of the graphite molding vessel 10. Furthermore, in a preferred embodiment, the elastic member 30C is a continuous annular body which has a ring-form cross section; this ring shape is appropriately selected in accordance with the cross-sectional shape of the inside surface of the tubular body 11 of the graphite molding vessel 10. Moreover, the cross-sectional shape of the inside surface of the elastic member 30C is appropriately selected in accordance with the target shape of the synthetic silica member 50 after the press-molding. In a preferred embodiment, the width of the elastic member 30C (see W30C in FIG. 1) may be preset at a value that is equal to or less than the target thickness of the synthetic silica glass bulk 50 after the molding (see T50 in FIG. 2).

Furthermore, there are no particular restrictions on the constituent materials of the elastic members 30A, 30B and 30C, as long as these constituent materials are materials which have a sufficient elasticity and porosity (ventilating properties) even at high temperatures, and which function as a medium that can sufficiently absorb compressive stress and tensile stress that arise from differences in shrinkage that occur between the synthetic silica glass bulk 50 and the graphite molding vessel 10 during press-molding. Plate-form felt members made of carbon fibers, woven or unwoven fabrics made of carbon fibers, or woven or unwoven fabrics made of ceramic fibers, are especially preferable for the use. In particular, plate-form felt members made of carbon fibers are particularly preferable from the standpoint of heat resistance.

The elastic members 30A, 30B and 30C have a bulk density in the range of about 0.1 g/cm³ to about 0.5 g/cm³, and the respective thicknesses of these members are in the range of about 1 mm to about 30 mm. Moreover, two or more elastic members may be superimposed in order to adjust the thickness.

In a preferred embodiment, the weight 40 is formed with a short cylindrical shape using carbon graphite or a ceramic, etc., as the constituent material. This weight 40 presses the synthetic silica glass bulk 50 at a high temperature, so that this synthetic silica glass bulk 50 is molded into a shape that conforms to the shape of the space that is formed by the graphite molding vessel 10 and weight 40.

Furthermore, as is shown in FIGS. 1, 3 and 4, engaging parts 41 are formed in a total of five places located at equal intervals on the peripheral edge portion of the lower part of the weight 40. Each of these engaging parts 41 may be formed in a substantially L-shaped configuration constructed of a vertical part 41a and a horizontal part 41b. The horizontal parts 41b are inserted into and engaged with groove-form engaged parts 31 that are formed in the peripheral edge portion of the elastic member 30A, so that the elastic member 30A is mounted in a state in which this elastic member 30A is caused to adhere tightly to the bottom surface of the weight 40. In this example, a fastener is constructed of the engaging parts 41 and the engaged parts 31.

The electric furnace 20 is equipped with a heater 22 and a temperature control part 24 that controls the output of this heater 22. This electric furnace 20 has a structure that allows the introduction of a pressurized inert gas into the interior of the electric furnace 20 by pressing. Moreover, in a preferred embodiment, the electric furnace 20 is equipped with a rotatable placement stand (not shown in the figures), and constructed so that the graphite molding vessel 10 placed on this placement stand can be rotated.

In order to ensure that the rotation of the placement stand has a favorable effect on the synthetic silica glass bulk 50 during molding, it is desirable to arrange the system so that the axis of rotation AX of the placement stand passes through the center of gravity of the synthetic silica glass bulk 50 when the graphite molding vessel 10 is placed on the placement stand.

In a preferred embodiment, the temperature control part 24 is used to retain the temperature inside the electric furnace 20 in the desired temperature range when press-molding of the synthetic silica glass bulk 50 is performed. This temperature control part 24 monitors the temperature inside the electric furnace 20, and controls the output of the heater 22. Furthermore, in a preferred embodiment the temperature control part 24 has a function of setting and controlling the time for performing the press-molding via software or the like.

Below, one example of the synthetic silica glass molding method of the present invention will be described with reference to FIGS. 1 and 2. First, a synthetic silica glass ingot is manufactured by the direct method or VAD method, and this ingot is further cut to produce a synthetic silica glass bulk 50 which has a specified size and shape. Next, as is shown in FIG. 1, this synthetic silica glass bulk 50 is placed inside the graphite molding vessel 10, to which the bottom plate 14 has been attached. Here, elastic members 30B and 30C which have ventilating properties are disposed as shown in FIG. 1 when the synthetic silica glass bulk 50 is placed inside the graphite molding vessel 10.

After the elastic member 30A has been mounted beforehand to the weight 40 by the engagement of the engaged parts 31 and engaging parts 41, and the synthetic silica glass bulk 50 has been positioned inside the graphite molding vessel 10, the weight 40 to which the elastic member 30A has been mounted is placed on top of this synthetic silica glass bulk 50. Next, the top plate 12 is attached, and the graphite molding vessel 10 is then placed inside the electric furnace 20, as shown in FIG. 1.

Next, an inert gas which has been pressurized to a pressure equal to or greater than atmospheric pressure is introduced into the interior of the electric furnace 20, and the atmosphere inside this electric furnace 20 is replaced by the pressurized inert gas. There are no particular restrictions on the inert gas that is used; a gas that does not react with the synthetic silica glass bulk 50, the graphite molding vessel 10 or the elastic members 30A, 30B and 30C that possess ventilating properties under the temperature conditions of the press-molding process may be appropriately selected. For example, N₂, Ar, He or H₂ may be used.

Furthermore, it is preferable that the partial pressure of the inert gas inside the electric furnace 20 be about 0.05 to about 1.0 MPa. If the partial pressure of the inert gas inside the electric furnace 20 is less than about 0.05 MPa, the synthetic silica glass tends to volatilize, so that there is an increased tendency toward generation of gas bubbles inside the synthetic silica glass bulk, which is undesirable. On the other hand, if the partial pressure of the inert gas inside the electric furnace 20 exceeds about 1.0 MPa, there is an increased tendency toward causing damage to the synthetic silica glass bulk 50 and graphite molding vessel 10, etc.

Next, the electric furnace 20 is operated so that molding of the synthetic silica glass bulk 50 is performed. Here, the process of temperature elevation, temperature retention and temperature lowering during molding is performed according to a specified program that is set in the control part 24 of the electric furnace 20 in advance. Furthermore, the graphite molding vessel 10 is caused to rotate during the processes of temperature elevation, temperature retention and temperature lowering that are performed during molding.

The synthetic silica glass bulk 50 is caused to undergo thermal deformation inside the electric furnace 20 as a result of its own weight and the weight of the weight 40, so that the synthetic silica glass bulk 50 is molded according to a shape that is determined by the elastic members 30A, 30B and 30C inside the graphite molding vessel 10.

The gas bubbles that are generated inside the synthetic silica glass bulk 50 during such press-molding are quickly allowed to escape to the outside of the synthetic silica glass bulk 50 by the elastic members 30A through 30C with ventilating properties that are inserted between the synthetic silica glass bulk 50 and the graphite molding vessel 10. As a result, the amount of gas bubbles remaining inside the resulting synthetic silica member 50 after the molding can be sufficiently suppressed. Furthermore, the elastic members 30A through 30C with ventilating properties also function as an absorbing medium that absorbs the compressive stresses and tensile stresses that are generated between the synthetic silica glass bulk 50 and graphite molding vessel 10. Accordingly, generation of stress between these parts in the cooling process following press-molding can be sufficiently suppressed. As a result, no cracking or damage occurs in the graphite molding vessel 10 or the resulting synthetic silica member 50 during and after the molding.

The synthetic silica glass molding method and molding apparatus of the present invention will be described in more detail below with reference to working examples shown in Table 1. In the following description, parts which are the same as constituent elements shown in FIG. 1, or which correspond to such constituent elements, will be labeled with the same symbols for simplicity.

TABLE 1

| | | Use of method | | Treatment | | | Acceptability |
|---|---|---|---|---|---|---|---|
| | Crucible | of the present | | pressure | Temperature | Retention | of thermal |
| | shape | invention | Atmosphere | (MPa) | (° C.) | time (min) | molding |
| Working | φ 220 | Yes | N2 | 0.4 | 1800 | 30 | ◯ |
| Example 1 | | | | | | | |
| Working | φ 220 | Yes | N2 | 0.6 | 1775 | 60 | ◯ |
| Example 2 | | | | | | | |
| Working | □ 160 | Yes | N2 | 0.2 | 1800 | 30 | ◯ |
| Example 3 | | | | | | | |
| Working | □ 160 | Yes | N2 | 0.5 | 1775 | 60 | ◯ |
| Example 4 | | | | | | | |
| Comparative | φ 220 | No | N2 | 0.2 | 1825 | 30 | X |
| Example 1 | | | | | | | |
| Comparative | φ 220 | No | N2 | 0.6 | 1775 | 60 | X |
| Example 2 | | | | | | | |
| Comparative | □ 160 | No | N2 | 0.6 | 1775 | 60 | X |
| Example 3 | | | | | | | |

### Working Example 1

In Working Example 1, the crucible shape of the graphite molding vessel 10 was a cylindrical shape with a diameter of 220 mm, and a graphite molding vessel in which the engaging parts 41 and engaged parts 31 of the present invention were installed was used. Furthermore, inside this graphite molding vessel 10, elastic members 30A, 30B and 30C made of carbon fibers manufactured by Nippon Carbon Co. Ltd., sold under the trademark “CARBOLON FELT” (CARBOLON FELT is a registered trademark) were respectively disposed in the same manner as shown in FIG. 1.

Furthermore, the respective thicknesses of the carbon fiber elastic members 30B and 30C were 2˜3 mm and 10 mm, and the bulk density was set at 0.1 g/cm³ in all cases. Moreover, the elastic member 30A was obtained by superimposing two elastic members similar to the elastic member 30B. In other words, the thickness of the elastic member 30A was set at 4˜6mm.

Next, a cylindrical synthetic silica glass bulk 50 was accommodated inside the graphite molding vessel 10 in a state similar to that shown in FIG. 1. Afterward, the carbon fiber elastic member 30A and the graphite weight (total weight: 5 kg) 40 were placed on top of the synthetic silica glass bulk 50, and the top plate 12 was attached to the graphite molding vessel 10. Next, the graphite molding vessel 10 accommodating the cylindrical synthetic silica glass bulk 50 was placed on a rotatable placement stand inside the electric furnace 20 in the same state as in FIG. 1.

Next, N₂ (0.4 MPa) was introduced into the electric furnace 20 as an inert gas, so that the air inside the electric furnace 20 was replaced by N₂. Afterward, while the placement stand inside the electric furnace 20 was rotated with the rotational speed retained at 1 rpm, the interior of the electric furnace 20 was heated at a temperature elevation rate of 10° C./min until the temperature reached 1800° C. After the interior of the electric furnace 20 reached a temperature of 1800° C., the interior of the furnace was retained at this temperature for 30 minutes, and the synthetic silica glass bulk 50 inside the graphite molding vessel 10 was press-molded at a treatment pressure of 0.4 MPa. After 30 minutes had elapsed, the interior of the electric furnace 20 was cooled to room temperature at a temperature lowering rate of 4° C./min. Following this cooling, the press-molded cylindrical synthetic silica glass (diameter 220 mm×height 30 mm) was extracted from the interior of the graphite molding vessel 10.

### Working Example 2

In Working Example 2, a synthetic silica glass was obtained by press-molding in the same manner as in Working Example 1, except that the treatment pressure was set at 0.6 MPa, the temperature was set at 1775° C., and the retention time was set at 60 min.

### Working Example 3

In Working Example 3, a synthetic silica glass was obtained by press-molding in the same manner as in Working Example 1, except that the crucible shape of the graphite molding vessel 10 was 160 mm square, and the treatment pressure was set at 0.2 MPa.

### Working Example 4

In Working Example 4, a synthetic silica glass was obtained by press-molding in the same manner as in Working Example 1, except that the crucible shape of the graphite molding vessel 10 was 160 mm square, the treatment pressure was set at 0.5 MPa, the temperature was set at 1775° C., and the retention time was set at 60 minutes.

### Comparative Example 1

In this example, a synthetic silica glass was obtained by press-molding in the same manner as in Working Example 1, except that the engaging parts 41 and engaged parts 31 of the present invention were not installed, the treatment pressure was set at 0.2 MPa, and the temperature was set at 1825° C.

### Comparative Example 2

In this example, a synthetic silica glass was obtained by press-molding in the same manner as in Working Example 2, except that the engaging parts 41 and engaged parts 31 of the present invention were not installed.

### Comparative Example 3

In this example, a synthetic silica glass was obtained by press-molding in the same manner as in Working Example 4, except that the engaging parts 41 and engaged parts 31 of the present invention were not installed, and the treatment pressure was set at 0.6 MPa.

Evaluation

Working Examples 1 through 4 and Comparative Examples 1 through 3 were compared. It was found that in Working Examples 1 through 4, in which the engaging parts 41 and engaged parts 31 of the present invention were installed, the acceptability of the thermal molding was graded as “◯,” indicating that synthetic silica glasses with a desired shape were successfully obtained. On the other hand, in the case of Comparative Examples 1 through 3, in which the engaging parts 41 and engaged parts 31 of the present invention were not installed, the acceptability of the thermal molding was graded as “X,” indicating that synthetic silica glasses with a desired shape were not obtained.

The reason for these results is considered as follows: by engaging the engaging parts 41 of the weight 40 with the engaged parts 31 of the elastic member 30A, the weight 40 and elastic member 30A were caused to adhere tightly to each other, so that no space was generated between these parts. Consequently, in Working Examples 1 through 4, synthetic silica glasses with a desired shape were successfully obtained.

Furthermore, it was confirmed that the installation of the elastic members 30A, 30B and 30C makes it possible to achieve sufficient suppression of the quantity of gas bubbles remaining in the molded synthetic silica glass, so that synthetic silica glass can be manufactured with a good yield.

In addition, it was also confirmed that the disposition of an elastic member 30C with ventilating properties around the side surface of the synthetic silica glass bulk 50 prevents cracking and damage of the molding vessel 10 as well so that synthetic silica glass can be manufactured with a higher productivity.

Furthermore, in the above-mentioned examples, the engaging parts 41 and engaged parts 31 are used as a fastener for fastening the elastic member to the pressing member. However, the present invention is not limited to this. For example, the fastener may be constructed by forming the pressing member and the elastic member from the same material, and fastening the elastic member tightly to the pressing member by thermal fusion. In such a case, flexing of the elastic member 30A can be prevented by the thermal fusing of the carbon weight 40 to the carbon fiber elastic member 30A, thus preventing the generation of a space between the weight 40 and the elastic member 30A.

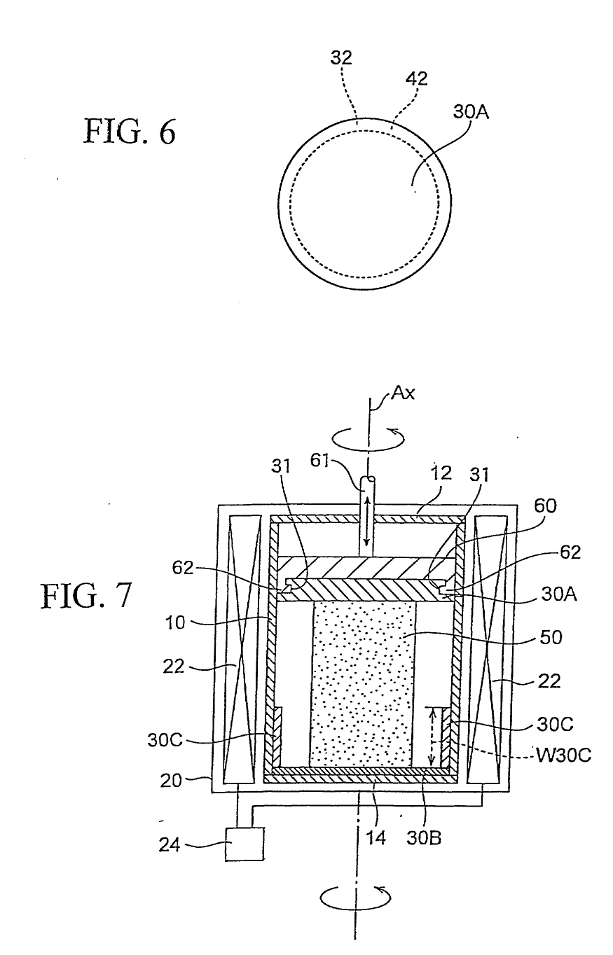

In the above examples, a plurality of substantially L-shaped parts were installed as the engaging parts. However, as will be appreciated by those skilled in the art, the present invention is not limited to this. For example, it is also possible to install a continuous engaging part 42 with a substantially L-shaped cross section on the weight 40 and to install a continuous engaged part 32 with which this engaging part 42 is engaged in the elastic member 30A, as shown in FIGS. 5 and 6. Of course, the shapes and other characteristics of the engaging part(s) and engaged part(s) are not limited to the above-mentioned examples, and various other shapes and constructions are possible.

Furthermore, in the above-mentioned working configuration, a weight 40 was provided as a pressing member. However, the present invention is not limited to this. Other members may be used as long as the member presses the synthetic silica glass bulk and deforms the bulk into a specified shape. For example, as shown in FIG. 7, a pressing shaft 61 may be fastened to a pressing plate 60 to constitute a pressing member. In such a case, the synthetic silica glass bulk 50 is pressed by the elastic member 30A by means of the pressing plate 60. The pressing shaft 61 may be lowered and elevated via any desired type of means such as a hydraulic system or mechanical system, etc. Here, substantially L-shaped engaging parts 62 are formed on the pressing plate 60, and the engaging parts 62 are inserted in and engaged with engaged parts 31 of the elastic member 30A.

Furthermore, in regard to the molding vessel, a graphite molding vessel 10 was described as an example. However, there are no particular restrictions on the constituent material of the molding vessel as long as this material can withstand use under the temperature and pressure conditions used in press-molding. For example, carbon materials other than graphite, as well as ceramic materials, can also be used.

In the examples above, a fastener is provided to fasten at least the peripheral edge portions of the elastic member tightly to the pressing member. As a result, flexing of the elastic member is prevented. Therefore, generation of a space between the elastic member and the pressing member is prevented. Consequently, the synthetic silica glass can be molded into a desired shape.

Furthermore, as a result of the installation of elastic members that have ventilating properties, generation of gas bubbles that remain inside the synthetic silica glass after the molding is sufficiently suppressed. Moreover, generation of stress between the synthetic silica glass bulk and the molding vessel in the cooling process following the molding is sufficiently suppressed.

Accordingly, a presently preferred embodiment of the invention provides a molding method and apparatus which allows the manufacture, at a good yield, of a synthetic silica glass with superior optical characteristics that has no residual gas bubbles or cracks, and which is suitable for use in (for example) reticle substrates and optical members of image-focusing optical systems, etc. The present invention is applicable to the press-molding of, for example, a synthetic silica glass manufactured using silicon compounds such as silicon tetrachloride, silane or organo-silicon compounds, etc., as raw materials, or a synthetic silica glass to which components that alter the refractive index, such as Ge, Ti, B, F or Al, etc., have been added.

Second Embodiment

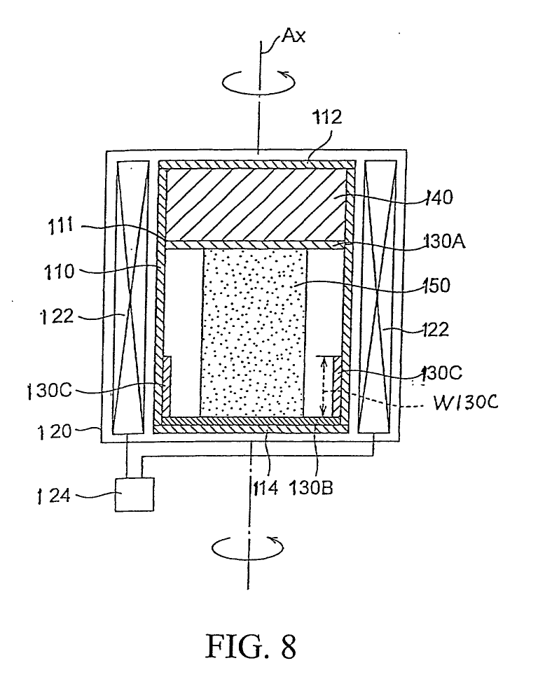

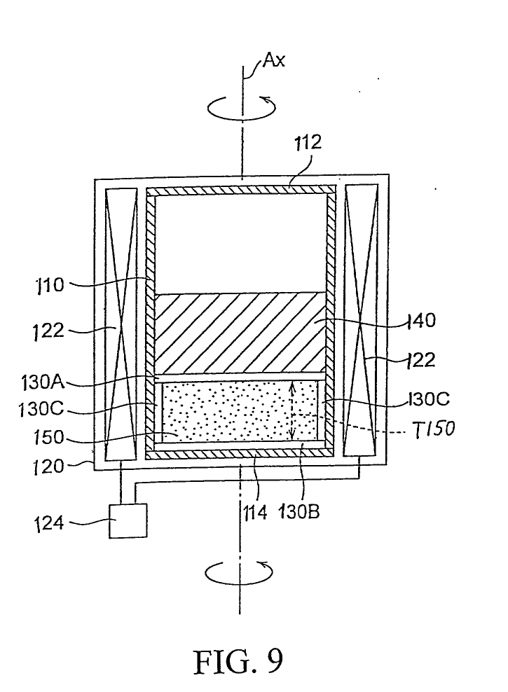

A second embodiment and working examples of the present invention will be described with reference to FIGS. 8 and 9. A synthetic silica glass molding apparatus of this embodiment has, as its principal components, a graphite molding vessel 110, a weight 140 used as a pressing member, felt members 130A, 130B and 130C, and an electric furnace 120.

The graphite molding vessel 110 is formed with a hollow structure in which a top plate 112 and a bottom plate 114 are fit over the upper surface and lower surface of a tubular body 111 made of graphite. A synthetic silica glass bulk 150 is accommodated inside this graphite molding vessel 110, and the vessel 110 is used for the press-molding of this synthetic silica glass bulk 150. The shape of the graphite molding vessel 110 is selected in accordance with the target shape of the synthetic silica member 150 after the press-molding. For example, a round shape or a rectangular shape may be used.

This graphite molding vessel 110 is a vessel whose ash content has been lowered to about 10 ppm or less by a purification treatment. Furthermore, the surface of this graphite molding vessel 110 may be coated with β-SiC. Examples of purification treatment methods that can be used include (1) a method in which the vessel is heated to a temperature of approximately 2000° C. in a vacuum state and treated by means of a pressure difference, and this treatment is repeated, and (2) a method in which the vessel is heated to a high temperature and treated in a hydrogen chloride atmosphere, etc. Furthermore, the porosity of this graphite molding vessel 110 is set at about 10% or less.

Furthermore, a felt member 130B is installed on the upper surface of the bottom plate 114, and the system is arranged so that the synthetic silica glass bulk 150 is carried on the felt member 130B. The weight 140 is placed on top of this synthetic silica glass bulk 150 with a felt member 130A that has ventilating properties interposed, and a felt member 130C which has ventilating properties is disposed on the inner surface of the lower portion of the tubular body 111.

The shapes and sizes of the felt members 130A and 130B are appropriately selected in accordance with the shape of the graphite molding vessel 110. Furthermore, the felt member 130C is a continuous annular body which has a ring-form cross section, and this ring shape is appropriately selected in accordance with the cross-sectional shape of the inside surface of the tubular body 111 of the graphite molding vessel 110. Moreover, cross-sectional shape of the inside surface of the felt member 130C is selected in accordance with the target shape of the synthetic silica member 150 after the press-molding. Furthermore, the width of the felt member 130C (see W130C in FIG. 8) is set in advance so that this width is equal to or less than the target thickness of the synthetic silica member 150 after the molding (see T150 in FIG. 9).

Furthermore, in regard to the constituent material of these felt members 130A, 130B and 130C, the felt members are formed into a plate form from carbon fibers to have a sufficient elasticity and porosity (ventilating properties) even at high temperatures and to function as a medium that can sufficiently absorb compressive stresses and tensile stresses arising from differences in shrinkage occurring between the synthetic silica glass bulk 150 and graphite molding vessel 110 during press-molding (i.e., a material that is used to relax stresses and suppress any deterioration in the synthetic silica glass bulk 150). Plate-form felt members 130A, 130B and 130C made of such carbon fibers are particularly preferable in terms of heat resistance.

Furthermore, the bulk density of the felt members 130A, 130B and 130C is preferably in the range of abut 0.05 to about 0.5 g/cm3, and the respective thicknesses of these felt members are preferably in the range of about 1 to about 30 mm. Furthermore, two or more felt members may be used in a superimposed configuration in order to adjust the thickness. Furthermore, felt members which have an ash content of about 10 ppm or less are used as these felt members 130A, 130B and 130C.

Furthermore, the weight 140 is formed into a short cylindrical shape using (for example) carbon graphite or a ceramic, etc., as the constituent material of the weight. The synthetic silica glass bulk 150 is pressed by this weight 140 at a high temperature, so that this synthetic silica glass bulk 150 is molded into a shape that conforms to the shape of the space formed by the graphite molding vessel 110 and the weight 140.

Furthermore, the electric furnace 120 is equipped with a heater 122 and a temperature control part 124 that controls the output of the heater 122. This electric furnace 120 has a structure that allows the introduction of a pressurized inert gas into the interior of the electric furnace 120 by pressing. Moreover, the electric furnace 120 is equipped with a rotatable placement stand (not shown in the figures), and is constructed so that the graphite molding vessel 110 placed on this placement stand can be rotated.

Here, in order to ensure that the rotation of the placement stand has a favorable effect on the synthetic silica glass bulk 150 during molding, it is desirable to arrange the system so that the axis of rotation AX of the placement stand passes through the center of gravity of the synthetic silica glass bulk 150 when the graphite molding vessel 110 is placed on the placement stand.

Furthermore, the temperature control part 124 is used to retain the temperature inside the electric furnace 120 in the desired temperature range when press-molding of the synthetic silica glass bulk 150 is performed. This temperature control part 124 monitors the temperature inside the electric furnace 120, and controls the output of the heater 122. Furthermore, the temperature control part 124 also has a function of setting and controlling the time for performing press-molding via software or the like.

An example of the synthetic silica glass molding method of the present invention will be described with reference to FIGS. 8 and 9. First, a synthetic silica glass ingot is manufactured by the direct method or VAD method, and this ingot is further cut to produce a synthetic silica glass bulk 150 which has a specified size and shape. Next, as is shown in FIG. 8, this synthetic silica glass bulk 150 is placed inside the graphite molding vessel 110, to which the bottom plate 114 has been attached. Here, felt members 130B and 130C which have ventilating properties are disposed as shown in FIG. 8 when the synthetic silica glass bulk 150 is placed inside the graphite molding vessel 110.

With the felt member 130A interposed, the weight 140 is placed on the synthetic silica glass bulk 150 accommodated inside the graphite molding vessel 110. Then, the top plate 112 is attached, after which the graphite molding vessel 110 is placed inside the electric furnace 120 as shown in FIG. 8. Next, an inert gas which has been pressurized to a pressure equal to or greater than atmospheric pressure is introduced into the interior of the electric furnace 120, and the atmosphere inside this electric furnace 120 is replaced by the pressurized inert gas. As a result, the problem of the formation of silicon carbide as a result of a reaction between the synthetic silica glass bulk 150 and the graphite molding vessel 110 can be prevented more effectively.

Here, there are no particular restrictions on the inert gas that is used. For example, a gas that does not react with the synthetic silica glass bulk 150, the graphite molding vessel 110 or the felt members 130A, 130B and 130C that possess ventilating properties under the temperature conditions of the press-molding process may be appropriately selected. For example, N₂, Ar, He or H₂ may be used.

Furthermore, it is preferable that the partial pressure of the inert gas inside the electric furnace 120 be about 0.05 to about 1.0 MPa. If the partial pressure of the inert gas inside the electric furnace 120 is less than about 0.05 MPa, the synthetic silica glass tends to volatilize to that there is an increased tendency toward generation of gas bubbles inside the synthetic silica glass bulk 150, which is not desirable. On the other hand, if the partial pressure of the inert gas inside the electric furnace 120 exceeds about 1.0 MPa, there is an increased tendency toward causing damage to the synthetic silica glass bulk 150 and graphite molding vessel 110, etc.

Next, the electric furnace 120 is operated so that molding of the synthetic silica glass bulk 150 is performed. Here, the process of temperature elevation, temperature retention and temperature lowering during molding is performed according to a specified program that is set in the control part 124 of the electric furnace 120 in advance. In this case, the treatment temperature during molding is set at about 1750° C. to about 1850° C., and the treatment time is set at about 10 minutes to about 60 minutes. In this way, the problem of a reaction between the constituent materials of the synthetic silica glass bulk 150 and graphite molding vessel 110 can be more effectively prevented. Furthermore, crystallization of the synthetic silica glass bulk can also be more effectively suppressed. Moreover, the formation of recesses and projections in the surface of the resulting synthetic silica glass and occurrence of cracking can be effectively prevented. In addition, by performing press-molding in such temperature and retention time ranges, it is also possible to achieve sufficient suppression of gas bubbles generated in the interior of the synthetic silica glass bulk 150.

Furthermore, the graphite molding vessel 110 is caused to rotate during the processes of temperature elevation, temperature retention and temperature lowering that are performed during molding. The synthetic silica glass bulk 150 undergoes thermal deformation inside the electric furnace 120 as a result of its own weight and the weight of the weight 140, and is molded into a shape that is determined by the felt members 130A, 310B and 130C inside the graphite molding vessel 110 (see FIG. 9).

The gas bubbles that are generated inside the synthetic silica glass bulk 150 during such press-molding are quickly allowed to escape to the outside of the synthetic silica glass bulk 150 via the felt members 130A through 130C with ventilating properties that are inserted between the synthetic silica glass bulk 150 and the graphite molding vessel 110. Consequently, the amount of gas bubbles remaining in the interior of the resulting synthetic silica member 150 after the molding can be sufficiently suppressed. Furthermore, the felt members 130A through 130C that have ventilating properties also function as a medium that absorbs compressive stress and tensile stress that occur between the synthetic silica glass bulk 150 and the graphite molding vessel 110. Accordingly, the generation of such stresses between the synthetic silica glass bulk 150 and the graphite molding vessel 110 during the cooling process following press-molding can be sufficiently suppressed. Consequently, no cracking or damage occurs in the resulting synthetic silica member 150 during and after the molding (i.e., the synthetic silica glass) or the graphite molding vessel 110.

Among metal impurities, alkali metals may be regarded as a particularly relevant factor causing deleterious effects on the transmissivity in the vacuum ultraviolet region. However, diffusion of metal impurities into the interior of the synthetic silica glass can be suppressed by using members that have been purified to an ash content of about 10 ppm or less as the graphite molding vessel 110 and felt members 130A, 130B and 130C, as described above.

Furthermore, by coating the surface of the graphite molding vessel 110 with a β-SiC coating film, diffusion of impurities from the graphite molding vessel 110 is further suppressed, so that the loss of uniformity in the in-plane transmissivity can be further suppressed. Here, it is preferable that the coating film that is applied to the surface of the graphite molding vessel 110 be β-SiC rather than α-SiC. If an α-SiC coating film is used, the grain size of the crystals is small and grain boundaries become numerous. Thus, there is little effect on impurities.

Furthermore, as a result of the surface of the graphite molding vessel 110 being coated with β-SiC, which has a higher thermal conductivity than graphite, heat transfer can be accomplished more effectively, so that uniformity in the temperature of the molded article (synthetic silica glass) can be obtained more efficiently. As a result, crystallization is less likely to occur, and it is possible to prevent generation of recesses and projections in the surface of the resulting synthetic silica glass member during and after the treatment, as well as the loss of transparency and the generation of cracks, etc.

Furthermore, when β-SiC is applied as a coating, the diffusion via fine holes in the graphite molding vessel 110 of (for example) fluorine that is released from the interior of the synthetic silica glass can be suppressed. As a result, a concentration distribution tends not to be formed in the synthetic silica glass, so that there is no deterioration in the optical characteristics in this regard.

In the synthetic silica glass molded in this manner, the amplitude of the fluctuation in the transmissivity in the direction perpendicular to the axis along which light is transmitted through the member (the optical axis) may be set at about ±1% or less per centimeter of the thickness of the member in the wavelength region of about 250 nm or less, so that the glass can be used in an ultraviolet to vacuum ultraviolet exposure apparatus.

Alternatively, in this synthetic silica glass, the amplitude of the fluctuation in the transmissivity in the direction perpendicular to the optical axis may be set at about ±0.5% or less per ¼ inch of the thickness of the member at a wavelength of 157.6 nm. Also, fluorine may be contained in the member, and the concentration of OH groups in the member may be set at about 1 ppm or less, so that the glass can be used in a vacuum ultraviolet exposure apparatus.

Furthermore, in the synthetic silica glass molded as described above, the total concentration of metal impurities contained in the member may be set at about 50 ppb or less, so that the glass can be used in an ultraviolet to vacuum ultraviolet exposure apparatus. Moreover, in the synthetic silica glass, the fluctuation in the concentration of fluorine contained in the member may be set at about 0.5 wt % or less, so that the glass can be used in an ultraviolet to vacuum ultraviolet exposure apparatus. Furthermore, the above-mentioned synthetic silica glasses may be used as lens members or photo-mask members in an ultraviolet to vacuum ultraviolet exposure apparatus.

Working examples of the synthetic silica glass molding method of the present invention will be described in more detail. Tables 2 and 3 list the working examples. In the following description, parts which are the same as the constituent elements shown in FIG. 8, or which correspond to such constituent elements, will be labeled with the same symbols for simplicity.

TABLE 2

| | | Ash | | | | | | |
|---|---|---|---|---|---|---|---|---|
| | Crucible | content | | Porosity | | Pressure | Temperature | Retention time |
| | shape | (ppm) | Coating | (%) | Atmosphere | (MPa) | (° C.) | (min) |
| Working | φ 220 | <10 | ◯ | 5 | N2 | 0.6 | 1800 | 30 |
| Example 5 | | | | | | | | |
| Working | φ 220 | <10 | ◯ | 8 | N2 | 0.6 | 1775 | 60 |
| Example 6 | | | | | | | | |
| Working | □ 160 | <10 | ◯ | 7 | N2 | 0.6 | 1800 | 30 |
| Example 7 | | | | | | | | |
| Working | □ 160 | <10 | ◯ | 3 | N2 | 0.6 | 1775 | 60 |
| Example 8 | | | | | | | | |
| Working | φ 220 | <10 | X | 15 | N2 | 0.6 | 1820 | 30 |
| Example 9 | | | | | | | | |
| Working | φ 220 | <10 | ◯ | 15 | N2 | 0.6 | 1750 | 60 |
| Example 10 | | | | | | | | |
| Working | □ 160 | <10 | X | 7 | N2 | 0.6 | 1775 | 60 |
| Example 11 | | | | | | | | |
| Working | □ 160 | <10 | ◯ | 3 | N2 | 0.6 | 1800 | 30 |
| Example 12 | | | | | | | | |
| Working | φ 220 | <10 | ◯ | 5 | N2 | 0.6 | 1750 | 60 |
| Example 13 | | | | | | | | |
| Working | □ 160 | <10 | ◯ | 7 | N2 | 0.6 | 1775 | 60 |
| Example 14 | | | | | | | | |
| Comparative | φ 220 | 15 | X | 8 | N2 | 0.6 | 1825 | 30 |
| Example 4 | | | | | | | | |
| Comparative | φ 220 | 15 | X | 15 | N2 | 0.6 | 1775 | 60 |
| Example 5 | | | | | | | | |

TABLE 3

| | | | Amplitude | | | | | Amplitude |
|---|---|---|---|---|---|---|---|---|
| | | | of | | | | | of |
| | | | fluctuation | Amplitude of | | | | fluctuation |
| | | | in | fluctuation in | Fluorine | | Concentration | in fluorine |
| | Shape | | transmis- | transmis- | concentra- | OH group | of metal | concentra- |
| | before | Shape after | sivity | sivity | tion | concentra- | impurities | tion |
| | treatment | treatment | (<250 nm) | (at 157.6 nm) | (wt %) | tion (ppm) | (ppb) | (wt %) |
| Working | φ 70 × t200 | φ 220 × t20 | <± 1.0 | <± 0.5 | 2.5 | <1 | <50 | <0.5 |
| Example 5 | | | | | | | | |
| Working | φ 70 × t200 | φ 220 × t20 | <± 1.0 | <± 0.5 | 2.5 | <1 | <50 | <0.5 |
| Example 6 | | | | | | | | |
| Working | φ 70 × t200 | □ 160 × t25 | <± 1.0 | <± 0.5 | 1.5 | <1 | <50 | <0.5 |
| Example 7 | | | | | | | | |
| Working | φ 70 × t200 | □ 160 × t25 | <± 1.0 | <± 0.5 | 2.5 | <1 | <50 | <0.5 |
| Example 8 | | | | | | | | |
| Working | φ 70 × t200 | φ 220 × t20 | <± 1.0 | <± 0.5 | 2.5 | <1 | <50 | <0.5 |
| Example 9 | | | | | | | | |
| Working | φ 70 × t200 | φ 220 × t20 | <± 1.0 | <± 0.5 | 2.5 | <1 | <50 | <0.5 |
| Example 10 | | | | | | | | |
| Working | φ 70 × t200 | □ 160 × t25 | <± 1.0 | <± 0.5 | 2.0 | <1 | <50 | <0.5 |
| Example 11 | | | | | | | | |
| Working | φ 70 × t200 | □ 160 × t25 | <± 1.0 | <± 0.5 | 2.0 | <1 | <50 | <0.5 |
| Example 12 | | | | | | | | |
| Working | φ 70 × t200 | φ 220 × t20 | <± 1.0 | — | — | 900 | <50 | — |
| Example 13 | | | | | | | | |
| Working | φ 70 × t200 | □ 160 × t25 | <± 1.0 | — | — | 1200 | <50 | — |
| Example 14 | | | | | | | | |
| Comparative | φ 70 × t200 | φ 220 × t20 | <± 1.5 | <± 2.0 | 2.5 | <1 | 100 | <1.5 |
| Example 4 | | | | | | | | |
| Comparative | φ 70 × t200 | φ 220 × t20 | <± 1.5 | <± 2.0 | 2.0 | <1 | 100 | <1.0 |
| Example 5 | | | | | | | | |

### Working Example 5

In Working Example 5, the crucible shape of the graphite molding vessel 110 that was used was a cylindrical shape with a diameter of 220 mm, and the ash content of this graphite molding vessel 110 was 10 ppm or less. Furthermore, the surface of this graphite molding vessel 110 was coated with β-SiC, and the porosity of the graphite molding vessel 110 was set at 5% (which is less than 10%).

Furthermore, carbon-fiber felt members 130A, 130B and 130C manufactured by Nippon Carbon Co. Ltd., sold under the trademark CARBOLON FELT (CARBOLON FELT is a registered trademark) were respectively disposed inside the graphite molding vessel 110 as in FIG. 8. These felt members 130A, 130B and 130C had an ash content of less than 10 ppm.

A cylindrical synthetic silica glass bulk 150 was accommodated inside the graphite molding vessel 110 in the same state as in FIG. 8. Afterward, the carbon-fiber felt member 130A and graphite weight 140 were placed on top of the synthetic silica glass bulk 150, and the top plate 112 was attached to the graphite molding vessel 110. Next, the graphite molding vessel 110 accommodating the cylindrical synthetic silica glass bulk 150 was placed on the rotatable placement stand inside the electric furnace 120 in the same state as in FIG. 8.

Next, N₂ (0.6 MPa) was introduced into the interior of the electric furnace 120 as an inert gas, so that the air inside the electric furnace 120 was replaced by N₂. Afterward, while the placement stand inside the electric furnace 120 was rotated with the rotational speed retained at 1 rpm, the interior of the electric furnace 120 was heated at a temperature elevation rate of 10° C./min until the temperature reached 1800° C. After the temperature inside the electric furnace 120 reached 1800° C., the interior of the electric furnace 120 was retained at this temperature for 30 minutes, and the synthetic silica glass bulk 150 inside the graphite molding vessel 110 was press-molded at a treatment pressure of 0.6 MPa. After 30 minutes had elapsed, the interior of the electric furnace 120 was cooled to room temperature at a temperature lowering rate of 4° C./min. Following cooling, the resulting press-molded cylindrical synthetic silica glass was removed from the interior of the graphite molding vessel 110.

The shape of this synthetic silica glass bulk 150 prior to the treatment showed a diameter of 70 mm and a height of 200 mm. The shape of the synthetic silica glass member after the treatment showed a diameter of 220 mm and a height of 20 mm.

In the synthetic silica glass thus molded, the amplitude of the fluctuation in the transmissivity in the direction perpendicular to the axis along which light is transmitted through the member (the optical axis) was ±1% or less per centimeter of the thickness of the member in the wavelength region of 250 nm or less. The amplitude of the fluctuation in the transmissivity in the direction perpendicular to the optical axis was ±0.5% per ¼ inch of the thickness of the member at a wavelength of 157.6 nm. Furthermore, in this synthetic silica glass, the amount of fluorine contained in the member was 2.5 wt %, the concentration of OH groups was less than 1 ppm, and the total amount of metal impurities contained in the member was less than 50 ppb. The amplitude of the fluctuation in the concentration of fluorine contained in the member was 0.5 wt % or less.

### Working Example 6

In Working Example 6, a synthetic silica glass was obtained by performing press-molding in the same manner as in Working Example 5, except that the porosity of the graphite molding vessel 110 was set at 8%, the treatment temperature was set at 1775° C., and the retention time was set at 60 minutes.

In the synthetic silica glass thus obtained, the resulting shape after the treatment, the amplitude of the fluctuation in the transmissivity (%), the fluorine concentration (wt %), the OH group concentration (ppm), the amount of metal impurities (ppb) and the amplitude of the fluctuation in the fluorine concentration (wt %) were the same as in Working Example 5.

### Working Example 7

In Working Example 7, a synthetic silica glass was obtained by performing press-molding in the same manner as in Working Example 5, except that the crucible shape of the graphite molding vessel 10 was 160 mm square, and the porosity of the graphite molding vessel 110 was set at 7%.

In the synthetic silica glass thus obtained, the resulting shape after the treatment was a rectangular solid shape measuring 160 mm on a side (regular square) with a height of 25 mm. The fluorine concentration was 1.5 wt %. Otherwise, the amplitude of the fluctuation in the transmissivity (%), the OH group concentration (ppm), the amount of metal impurities (ppb) and the amplitude of the fluctuation in the fluorine concentration (wt %) were the same as in Working Example 5.

### Working Example 8

In Working Example 8, a synthetic silica glass was obtained by performing press-molding in the same manner as in Working Example 5, except that the crucible shape of the graphite molding vessel 110 was 160 mm square, the porosity of the graphite molding vessel 110 was set at 3%, the retention temperature was set at 1775° C., and the retention time was set at 60 minutes.

In the synthetic silica glass thus obtained, the resulting shape after the treatment was a rectangular solid shape measuring 160 mm on a side (regular square) with a height of 25 mmn. Otherwise, the fluorine concentration (wt %), the amplitude of the fluctuation in the transmissivity (%), the OH group concentration (ppm), the amount of metal impurities (ppb) and the amplitude of the fluctuation in the fluorine concentration (wt %) were the same as in Working Example 5.

### Working Example 9

In Working Example 9, a synthetic silica glass was obtained by performing press-molding in the same manner as in Working Example 5, except that the surface of the graphite molding vessel 110 was not coated with β-SiC, the porosity of the graphite molding vessel 10 was set at 15%, and the treatment temperature was set at 1820° C.

In the synthetic silica glass thus obtained, the resulting shape after the treatment, the amplitude of the fluctuation in the transmissivity (%), the fluorine concentration (wt %), the OH group concentration (ppm), the amount of metal impurities (ppb) and the amplitude of the fluctuation in the fluorine concentration (wt %) were the same as in Working Example 5.

### Working Example 10

In Working Example 10, a synthetic silica glass was obtained by performing press-molding in the same manner as in Working Example 5, except that the porosity of the graphite molding vessel 110 was set at 15%, the treatment temperature was set at 1750° C., and the retention time was set at 60 minutes.

In the synthetic silica glass thus obtained, the resulting shape after the treatment, the amplitude of the fluctuation in the transmissivity (%), the fluorine concentration (wt %), the OH group concentration (ppm), the amount of metal impurities (ppb) and the amplitude of the fluctuation in the fluorine concentration (wt %) were the same as in Working Example 5.

### Working Example 11

In Working Example 11, a synthetic silica glass was obtained by performing press-molding in the same manner as in Working Example 5, except that the crucible shape of the graphite molding vessel 110 was 160 mm square, the surface of the graphite molding vessel 110 was not coated with β-SiC, the porosity of the graphite molding vessel 10 was set at 7%, the treatment temperature was set at 1775° C., and the retention time was set at 60 minutes.

In the synthetic silica glass thus obtained, the resulting shape after the treatment was a rectangular solid shape measuring 160 mm on a side (regular square) with a height of 25 mm. The fluorine concentration was 2.0 wt %. Otherwise, the amplitude of the fluctuation in the transmissivity (%), the OH group concentration (ppm), the amount of metal impurities (ppb) and the amplitude of the fluctuation in the fluorine concentration (wt %) were the same as in Working Example 5.

### Working Example 12

In Working Example 12, a synthetic silica glass was obtained by performing press-molding in the same manner as in Working Example 5, except that the crucible shape of the graphite molding vessel 110 was 160 mm square, and the porosity of the graphite molding vessel 10 was set at 3%.

In the synthetic silica glass thus obtained, the resulting shape after the treatment was a rectangular solid shape measuring 160 mm on a side (regular square) with a height of 25 mm. The fluorine concentration was 2.0 wt %. Otherwise, the amplitude of the fluctuation in the transmissivity (%), the OH group concentration (ppm), the amount of metal impurities (ppb) and the amplitude of the fluctuation in the fluorine concentration (wt %) were the same as in Working Example 5.

### Working Example 13

In Working Example 13, a synthetic silica glass was obtained by performing press-molding in the same manner as in Working Example 5, except that the treatment temperature was set at 1750° C., and the retention time was set at 60 minutes.

The shape of this synthetic silica glass bulk 150 prior to treatment was a cylindrical shape with a diameter of 70 mm and a height of 200 mm. The shape of the synthetic silica glass after the treatment was a cylindrical shape with a diameter of 220 mm and a height of 20 mm.

In the synthetic silica glass thus molded, the amplitude of the fluctuation in the transmissivity in the direction perpendicular to the axis transmitting light through the member was ±1% or less per centimeter of the thickness of the member in the wavelength region of 250 nm or less. Furthermore, in this synthetic silica glass, the concentration of OH groups was 900 ppm, and the total amount of metal impurities contained in the member was less than 50 ppb.

### Working Example 14

In Working Example 14, a synthetic silica glass was obtained by performing press-molding in the same manner as in Working Example 5, except that the crucible shape of the graphite molding vessel 110 was 160 mm square, the porosity of the graphite molding vessel 110 was set at 7%, the treatment temperature was set at 1755° C., and the retention time was set at 60 minutes.

The shape of this synthetic silica glass bulk 150 prior to treatment was a cylindrical shape with a diameter of 70 mm and a height of 200 mm. The shape of the synthetic silica glass after the treatment was a rectangular solid shape 160 mm on a side (regular square) with a height of 25 mm.

In the synthetic silica glass thus molded, the amplitude of the fluctuation in the transmissivity in the direction perpendicular to the axis transmitting light through the member was ±1% or less per centimeter of the thickness of the member in the wavelength region of 250 nm or less. Furthermore, in this synthetic silica glass, the concentration of OH groups was 1200 ppm, and the total amount of metal impurities contained in the member was less than 50 ppb.

### Comparative Example 4

In Comparative Example 4, the ash content was set at 15 ppm instead of 10 ppm or less as in the present invention; furthermore, the surface of the graphite molding vessel 110 was not coated with β-SiC, the porosity of the graphite molding vessel 110 was set at 8%, and the treatment temperature was set at 1825° C. Otherwise, a synthetic silica glass was obtained by press-molding in the same manner as in Working Example 5.

In the synthetic silica glass thus molded, the amplitude of the fluctuation in the transmissivity in the direction perpendicular to the axis along which light is transmitted through the member was as much as ±1.5% per centimeter of the thickness of the member in the wavelength region of 250 nm or less. Furthermore, the amplitude of the fluctuation in the transmissivity in the direction perpendicular to the axis transmitting light through the member was as much as ±2.0% per ¼ inch of the thickness of the member at a wavelength of 157.6 nm. Furthermore, in this synthetic silica glass, the amount of metal impurities contained in the member was large, at a total content of 100 ppb. Moreover, in this synthetic silica glass, the amplitude of the fluctuation in the concentration of fluorine contained in the member was as much as 1.5 wt % or less. The remaining values were the same as in Working Example 5.

### Comparative Example 5

In Comparative Example 5, the ash content was set at 15 ppm instead of 10 ppm or less as in the present invention, and the surface of the graphite molding vessel 110 was not coated with β-SiC. Furthermore, the porosity of the graphite molding vessel 10 was set at 15% (a value greater than 10%), the treatment temperature was set at 1775° C., and the retention time was set at 60 minutes. Otherwise, a synthetic silica glass was obtained by press-molding in the same manner as in Working Example 5.

In the synthetic silica glass thus molded, the amplitude of the fluctuation in the transmissivity in the direction perpendicular to the axis transmitting light through the member was as much as ±1.5% per centimeter of the thickness of the member in the wavelength region of 250 nm or less. Furthermore, the amplitude of the fluctuation in the transmissivity in the direction perpendicular to the axis transmitting light through the member was as much as ±2.0% per ¼ inch of the thickness of the member at a wavelength of 157.6 nm. Furthermore, in this synthetic silica glass, the fluorine concentration was 2.0 wt %, and the amount of metal impurities contained in the member was large, at a total content of 100 ppb. Moreover, in this synthetic silica glass, the amplitude of the fluctuation in the concentration of fluorine contained in the member was as much as 1.0 wt %. The remaining values were the same as in Working Example 5.

Evaluation

Working Examples 5 through 14 and Comparative Examples 4 and 5 are compared. First, it can be seen from the tables that in Comparative Examples 4 and 5, in which the ash content is greater than 10 ppm and the graphite molding vessel 110 is not coated with β-SiC, the amount of metal impurities is greater than those of Working Examples 5 through 14. Accordingly, it can be seen that in Working Examples 5 through 14, the diffusion of metal impurities into the interior of the synthetic silica glass can be suppressed by using members that have been purified to a point where the ash content is 10 ppm or less.

Furthermore, since coating of the surface of the graphite molding vessel 110 with a β-SiC coating film makes it possible to suppress the diffusion of impurities from the graphite molding vessel 110, such coating is desirable. However, it can be seen from the tables that for Working Examples 9 and 11, if the ash content is 10 ppm or less, the amount of metal impurities can be reduced even if no β-SiC coating is applied.

Furthermore, it can be seen that the amplitude of the fluctuation in the transmissivity and the amplitude of the fluctuation in the fluorine concentration are greater in Comparative Examples 4 and 5 than those of Working Examples 5 through 12.

In the above-mentioned examples, a weight 140 was installed as a pressing member. However, the present invention is not limited to such a pressing member. As long as the synthetic silica glass bulk can be pressed and deformed into the desired shape, other constructions can be used. For example, HIP (hot isostatic press) or mechanical pressing may be used.

In the examples above, members that have been purified so that the ash content is decreased are used as the graphite molding vessel and felt members. As a result, diffusion of metal impurities into the synthetic silica glass can be suppressed, so that the uniformity of the inplane transmissivity can be retained and improved. Furthermore, crystallization can be suppressed, and formation of recesses and projections in the surface of the synthetic silica glass following treatment, a loss of transparency, and generation of cracks can be suppressed.

If the graphite molding vessel and felt members are purified so that the ash content is made to be about 10 ppm or less, the above-mentioned effects of the present invention are obtained more effectively.

If the surface of the graphite molding vessel is coated with β-SiC, diffusion of impurities from the graphite molding vessel can be further suppressed, so that the abovementioned effects of the present invention can be further enhanced. Furthermore, as a result of the surface of the graphite molding vessel being coated with β-SiC, diffusion via fine holes in the graphite molding vessel of (for example) fluorine released from the interior of the synthetic silica glass can be suppressed. Consequently, concentration distribution is less likely to be generated inside the synthetic silica glass, and a deterioration in the optical characteristics can also be further suppressed.

In the present invention, the porosity of the graphite molding vessel may be set at about 10% or less. In this case, diffusion of impurities via fine holes in the graphite molding vessel can be further suppressed.

In the present invention, the atmosphere during the molding may be set as an inert gas atmosphere with a pressure that is equal to or greater than the atmospheric pressure. In this case, the problem of formation of silicon carbide due to the reaction of the synthetic silica glass bulk with the graphite molding vessel can be more effectively prevented.

In the present invention, the treatment temperature during the molding is preferably set at about 1750° C. to about 1850° C., and the treatment time is preferably set at about 10 minutes to about 60 minutes. In this case, the problem of a reaction between the synthetic silica glass bulk and the graphite molding vessel can be more effectively prevented.

Consequently, a synthetic silica glass which has optical characteristics suitable for optical members, such as reticle substrates and image-focusing optical systems, etc., can be manufactured with a good yield by press-molding a synthetic silica glass bulk that has been manufactured, for example, using a silicon compound such as silicon tetrachloride, silane or an organo-silicon compound as a raw material, or a synthetic silica glass to which components that alter the refractive index, such as Ge, Ti, B, F or Al, etc., have been added.

It will be apparent to those skilled in the art that various modifications and variations can be made in the separating method and apparatus of the present invention without departing from the spirit or scope of the invention. Thus, it is intended that the present invention cover the modifications and variations of this invention provided they come within the scope of the appended claims and their equivalents.

What is claimed is:

1. A synthetic silica glass molding method, comprising:
accommodating a synthetic silica glass bulk inside a molding vessel;
interposing an elastic member having a ventilating property between a pressing member and the synthetic silica glass bulk;
providing a fastener for fastening at least peripheral edge portions of the elastic member to the pressing member; and
pressing the synthetic silica glass bulk against the molding vessel by the pressing member in a high-temperature condition to mold the synthetic silica glass bulk into a synthetic silica glass member having a shape conforming to a shape of the space defined by the pressing member and the molding vessel, the synthetic silica glass bulk being pressed in such a manner that the pressing member and the elastic member tightly fasten to each other through the fastener.

2. The method according to claim 1, wherein providing the fastener includes forming the pressing member and the elastic member from the same material, and
wherein pressing the synthetic silica glass bulk against the molding vessel includes fastening the elastic member tightly to the pressing member by thermal fusion.

3. The method according to claim 1, wherein providing the fastener includes providing a first engaging part on the pressing member and providing in the elastic member a second engaging part configured to be engaged with the first engaging part, and
wherein pressing the synthetic silica glass bulk includes engaging the first engaging part on the pressing member with the second engaging part in the elastic member so as to fasten tightly the pressing member to the elastic member.

4. The method according to claim 3, wherein one of the first and second engaging parts has an L shape, and the other one of the first and second engaging parts has a groove shape to be engaged with the L-shaped engaging part.

5. The method according to claim 1, wherein the elastic member is a plate-form felt member made of carbon fibers.

6. The method according to claim 1, wherein the pressing member is a weight that presses against the upper surface of the synthetic silica glass bulk.

7. The method according to claim 1, wherein pressing the synthetic silica glass bulk against the molding vessel includes providing an inert gas atmosphere retained at an atmospheric pressure or higher.

8. A synthetic silica glass molding apparatus, comprising:
a molding vessel configured to accommodate a synthetic silica glass bulk;
a heater for heating the molding vessel;
a pressing member that presses the synthetic silica glass bulk in a high-temperature condition against the molding vessel to mold the synthetic silica glass bulk into a synthetic silica glass member having a shape conforming to the shape of a space defined by the pressing member and the molding vessel;
an elastic member having a ventilating property, configured to be interposed between the pressing member and the synthetic silica glass bulk; and
a fastener configured to fasten at least peripheral edge portions of the elastic member to the pressing member,
wherein the pressing member presses the synthetic silica glass bulk in such a manner that the pressing member and the elastic member tightly fasten to each other through the fastener.

9. The apparatus according to claim 8, wherein the fastener corresponds to a portion of the pressing member and a portion of the elastic member, each of which is made of the same material, and the portion of the pressing member and the portion of the elastic member undergo thermal fusion when the pressing member presses the synthetic silica glass bulk in the high-temperature condition so that the elastic member tightly is tightly fastened to the pressing member.

10. The apparatus according to claim 8, wherein the fastener includes a first engaging part on the pressing member and a second engaging portion in the elastic member, the first engaging part being engaged with the second engaging part when pressing member presses the synthetic silica glass bulk in the high temperature condition so that the elastic member is tightly fastened to the pressing member.

11. A synthetic silica glass molding method, comprising:
providing a graphite molding vessel that has been subjected to a purification treatment,
providing a pressing member;
providing a plate-form felt member made of carbon fibers on a surface of each of the graphite molding vessel and the pressing member to alleviate stress and suppress deterioration of a synthetic silica glass bulk to be molded, the plate-form felt member having been subjected to a purification treatment;
accommodating a synthetic silica glass bulk inside the graphite molding vessel; and
pressing the synthetic silica glass bulk against the molding vessel by the pressing member in a high-temperature condition to mold the synthetic silica glass into a synthetic silica member having a shape conforming to the shape of a space defined by the pressing member and the graphite molding vessel.

12. The method according to claim 11, wherein each of the graphite molding vessel and the felt member has an ash content of about 10 ppm or less.

13. The method according to claim 11, wherein the surface of the graphite molding vessel is coated with β-SiC.

14. The method according to claim 11, wherein the porosity of the graphite molding vessel is about 10% or less.

15. The method according to claim 11, wherein pressing the synthetic silica glass bulk against the molding vessel includes providing an inert gas atmosphere retained at an atmospheric pressure or higher.

16. The method according to claim 11, wherein pressing the synthetic silica glass bulk against the molding vessel includes retaining a treatment temperature at about 1750° C. to about 1850° C. for a time period ranging from about 10 minutes to about 60 minutes.

17. A synthetic silica glass member manufactured by any one of claim 11-16, wherein a fluctuation in transmissivity of the synthetic silica glass member in a direction perpendicular to an axis along which light is transmitted through the member is about ±1% or less per centimeter of the thickness of the member in the wavelength region of about 250 nm or less, and the synthetic silica glass member is adapted for use in an exposure apparatus employing light in the region of ultraviolet to vacuum ultraviolet.

18. The synthetic silica glass member according to claim 17, wherein the total concentration of metal impurities contained in the member is about 50 ppb or less.

19. The synthetic silica glass member according to claim 17, wherein a fluctuation in concentration of fluorine in the member is about 0.5 wt % or less.

20. The synthetic silica glass member according to claim 17, wherein the synthetic silica glass member is one of an exposure apparatus lens member and a photo-mask member for use in an exposure apparatus employing light in the region of ultraviolet to vacuum ultraviolet.

21. A synthetic silica glass member manufactured by any one of claim 11-16, wherein a fluctuation in transmissivity of the synthetic silica glass member in a direction perpendicular to an axis along which light is transmitted through the member is about ±0.5% or less per ¼ inch of the thickness of the member at a wavelength of about 157.6 nm, and the synthetic silica glass member is adapted for use in a vacuum ultraviolet exposure apparatus.

22. The synthetic silica glass member according to claim 21, wherein the synthetic silica glass member contains fluorine, and the concentration of the OH group in the synthetic silica glass member is about 1 ppm or less.
